(19) United States
(12) Patent Application Publication
(10) Pub. No.: US 2005/0197164 A1
(43) Pub. Date: Sep. 8, 2005

(54) Method for providing services via advertisement terminals

(76) Inventor: Brian Ka Kui Chan, Richmond Hill (CA)

Correspondence Address: Brian Ka Kui Chan, 76 Hillhurst Drive, Richmond Hill, ON, L4B 3C4, CA

(21) Appl. No.: 10/794,815

(22) Filed: Mar. 8, 2004

(51) Int. Cl. H04B 1/38

(52) U.S. Cl. 455/566

(57) ABSTRACT

A method enabling an advertiser to provide services to and collect data from user via an advertisement delivery terminal. Advertisers can provide customer services, conduct surveys, distribute coupons, and extend reach via advertisement terminals using the method of the present invention. In particular, an advertiser can add additional functions to advertisements when they are being delivered. The additional functions are independent of the advertisement to increase efficiency and flexibilities.

### CROSS-REFERENCE TO RELATED APPLICATIONS

Not Applicable

### REDERALLY SPONSORED RESEARCH

Not Applicable

### SEQUENCE LISTING OR PROGRAM

Not Applicable

### BACKGROUND OF THE INVENTION—FIELD OF INVENTION

The present invention relates generally to provide service via advertisement delivery terminals.

### BACKGROUND OF INVENTION—DISCUSSION OF PRIOR ART

Overview

The attraction of the Internet media to the general population is causing a significant shift in the traditional terminals of advertisement. And advertising has been a big topic in the Internet industry. There are many different forms of advertisements delivery method are used to deliver advertisements along with web pages.

The economic potential of the Internet is enormous. Revenue is directly proportional to the volume of qualified potential customers (“traffic”) that reach and view a commercial Web site. Each visit (often referred to as a “hit”) to a commercial Web site has economic value. Thus, the primary goal of Internet marketing is generating traffic. A secondary goal is to get potential customers to make purchases or otherwise use a commercial Web site (i.e., “capture traffic”). Traffic is more difficult to generate than it is to capture. Further, investment made to generate traffic produces a greater economic return than investment made to capture traffic. A company can spend a lot of money on effective Web site design so that potential customers will have a rewarding experience and thus a higher inclination to make a purchase once the customer has reached the Web site. But investment in Web site design is wasted unless the site is actually visited. A third goal is “branding,” or increasing consumer awareness or recognition of a brand.

In order to meet these goals, most Internet businesses use advertisements to promote their business according to their marketing plans. To have good return on advertisement, there are two major factors that affect the result of advertising on the internet. The two factors are the use of advertisement methods and the coverage of advertisement delivery. The advertisement method factor refers to which advertising method are used to delivery the content. In an online environment, advertisement method include browser related methods such as in page formats (Medium Rectangle, skyscraper, leader board, banner etc.) and window formats (interstitial, pop-up, pop-under, invue etc.) are commonly used. Alternative advertising method includes mass e-mail. The advertisement delivery coverage factor refers to how this advertisement reaches the target audience. For example, if a company has a great ad, but the ad is only shown to less than 1000 web user a month, no matter which advertisement method is used, the result is limited.

Advertising Methods

Browser based advertising is currently the primary method of advertising on the World Wide Web. Browser based advertising relies on HTML and some of the techniques used to create a Web site. Site maintainers insert HTML code in their Web pages that causes a small advertisement (sizes vary) to appear in a frame on the Web page, i.e., a “banner advertisement.” The HTML code also contains a link to another site.

Other known alternative advertising methods include pop-ups and a method disclosed in U.S. Patent Application No. 20020019834, titled “Post-session internet advertising system” to Andrew J. JR. Vilcauskas et al., filed on May 24, 2001. The invention uses pop-under windows to delivery ads after a user session ends. It works like a pop-up ad, but the user does not see the ads until the user finishes with the current sessions.

Advertisement distribution channel

The advertisement delivery channel factor refers to how well an advertisement can be delivered to target audience. In order to have a large coverage of publisher, advertisement delivery networks are getting popular. The advertisement delivery network usually comprises of a plurality of advertisers, a plurality of publishers, and an ad network server. The ad network server acts as a middle man between the advertisers and publisher. Advertisers log on to the ad network server and create advertisement campaigns by providing the advertisement (image, code etc.), resources (campaign limit, CPM, CPC price, and maximum budget etc.). Publishers also log on to the ad network server and sign up for publishing ads for the advertisers. In general, publishers insert specific code segment in their web pages to request ads from the ad network server. When the publisher's web site is loaded, a request is sent to the ad network server. The ad network server then determines which ad to deliver, and then transfer the ad information to the publisher. The publishers charges the advertisers a rate for deliver advertiser's ad, and the ad network server earn a percentage of the revenue the publishers make. The advantage of the advertisement delivery network is that they allow the advertisers to access a large amount of publisher by saving the effort to locate suitable publishers.

The Problem

Despite the effectiveness of all the above online advertising methods of the advertising method factor, the goal of each advertisement method is to attract more potential traffic to the advertisers' web page, get more potential business opportunities, and promote the products and services of a company. And the existent of advertisement delivery network is to help advertiser to expand their advertisement's reach by advertising via a large amount of qualifying publishers. However, with the competitions today, promoting business simply by showing a graphical ad or an ad with fancy animation may not be good enough to attract potential customers (even the ads are distributed via a large advertisement delivery network with a large amount of publisher). None of any existing advertising methods allow advertisers to provide services to user via advertisement delivery.

Although traditionally, advertising usually is a one directional process, that advertisers put advertisement on a publisher media, and their ads are delivered to the user online or offline. However, this process may be possible to be renovated as technologies advance. With the interactive nature of the internet, the one directional process is possible to be renovated to a bidirectional process, having information sends back to the advertisers from users. Even though there is nothing problematic about the advertising methods, but it is still possible to have some improvements on the traditional concept of advertising to improve the overall marketing performances.

There are methods attempts to increase the effectiveness of online advertisement method. Technologies such as using HTML code segment instead of an image or flash file, the HTML code segment contains code that allow users to post data through the segment. It is also known in the prior art that using HTML based advertisement instead of images where user can post data to advertiser's site using HTML form as disclosed in the latest version of deloittes.NET AdServe v1.1 a in house ad management product manufactured by deloittes.NET Ltd. The disclosed interactive advertisement has a few limits. The HTML based ads are embedded in the ad and not independent to the ad, if the advertiser wants to change ad content or the form content, they need to redesign the ad. AdServe v1.1 is developed to run in an in-house environment as the server may closely monitor the performance, but it is not optimal to work in an advertisement delivery network environment which advertisers is separated with the ad network server. And more, security is a big concern to publishers or users since code segments can be problematic and may conflict with publisher coding during delivery. It is because it is dangerous to allow unknown advertisers to insert program codes into publisher's web page while delivery. The ASPBanner product, manufactured by CJWSoft is another example of similar in house ad management software that allows HTML forms to replace the advertisement.

It is also known in the prior art as disclosed in the U.S. Patent Application No. 20020103698, titled “System and method for enabling user control of online advertising campaigns” to Christian Cantrell, filed on Dec. 1, 2000. The disclosed patent teaches how to create ad online and allow buyer to buy directly inside the ad. The disadvantage of this method is again that the interactive function of ad is embedded in the advertisement, this approach forces advertiser to create ad with limitations and restrictions. This method is not preferable by ad network server of the advertisement delivery network because it occupies the delivery resources while user is browsing through the ad. And the time control of when to load another ad would be a complicated task to the publisher or the ad network server. In the patent description, it also mentions of putting a mystery icon on an ad banner, if the mouse pointer is moved over the banner, a pop up menu comes up and the user may have 4 options. The last one is “email ad to a friend”. The function is hidden in the submenu of a first menu (the ad material/content). Moreover, the disclosed patent only provides links to the advertisement network to become either the advertiser or publisher, but there is no function that allows user to contact the advertiser directly or providing any feedback.

Therefore, the mentioned methods of using HTML code segment insertion instead of image ad, and the disclosed patent relates to creating online ad have some common technical problems. The problems include security issues of advertisement due to coding, timing control of function embedded advertisement, and coding compatibility with the code on publisher site. Beside the technical problem, there is also performance problems including advertisement size limitation (amount of functions able to provide within the limited advertisement size), and the consistent of both graphical content and function content.

In general, there is no prior art that allows advertiser to delivery ads efficiently via advertisement delivery network, and with the addition of providing independent, secure, reliable, and flexible services along with advertisement. Besides the problems existed in prior arts, here are some scenarios showing problems that no prior art attempts to solve.

Scenario 1, advertiser A has an advertisement campaign related to an on sale item, and it is being advertised via an advertisement delivery network. However, when user C sees the ad, he is not interested because the on sale item isn't one of the items he wants to buy. Therefore, user C simply ignores the advertisement and carries on with his web surfing. This situation is a trade off between potential customer and audience targeting. You may target specific customers, while missing others.

Scenario 2, a company wants to research on what consumers want in order to determine the company's business strategy. With current methods, the company needs to hire market research companies, having them to conduct a survey for them. Or the company can setup a little survey on its web site and ask visitors to answer questions. However, the problem with these approaches is either expensive, or not efficient due to the limited accessing sources. No prior art has used the advertising terminals to conduct surveys directly along advertisement without having users to visit a specific web site.

Thus, with known web marketing techniques there is no way of allowing user to perform desire actions to the advertisement. A banner advertisement, pop up window, pop under, or other Internet advertisement may successfully delivery the content to users, but they are only one directional. Known techniques do not allow users to communicate with the advertisers, keep record of advertisement directly and effectively.

Another niche that no prior art attempts to satisfy is using the advertisement delivery or delivery channel to delivery coupons, rebates, and flyers. In a scenario 3, advertiser B is having short term promotion on a product and having a coupon associated with the product, the ads basically forward the user to a web page that contains the coupon. In this case, if the user wants to buy the promoting item, he needs to select or click on the ad, then after forwarded to the page, then obtain the coupon, and further to use and redeem it. However, if the coupon is distributed along with the advertisement, it would be easier for the users to obtain it, and further increase the efficiency of the coupon.

Scenario 3 also shows that no web marketing techniques discussed above teaches how to provide a method to distribute e-coupon via advertisement terminals. There are many inventions and existing systems that aim on coupon distribution and redemption.

It is known in the prior arts that coupon redemption can be done online. Invention such as U.S. Pat. No. 6,584,448, titled “Method of and system for distributing and redeeming electronic coupons” to Laor, Jun. 24, 2003, and U.S. Pat. No. 6,336,099, titled “Method and system for electronic distribution of product redemption coupons” to Barnett et al., Jan. 1, 2002. All these patents are related to using and securing coupon distribution and redemption. However, none of these prior arts attempt to distribute coupons and rebates via advertisement terminals. It is known that advertisement delivery terminals have much higher penetration ability, comparing with current “coupon sites” and other coupon distribution techniques. While these inventions attempt to provide a better distribution system for distribution and redemption coupons online, but they all fail to provide a good solution of increasing the efficiency of coupon distribution.

The scenarios above show that there are opportunities to provide interactive services via advertisement delivery using techniques and methods of online advertisement delivery network to provide advertisement independent services, while providing security, reliabilities and flexibilities. It is known that consumers do not want fancy advertisements; they would rather have solid services that prove the capabilities of the advertisers.

### BACKGROUND OF INVENTION—OBJECTS AND ADVANTAGES

An object of the present invention is to provide a method which improves online advertisement result by adding advertisement-independent add-on services to existing online advertisement methods whereby advertisers can interact with users via advertisement delivery.

Another object of the present invention is to provide a method which allows users to communicate with advertisers through advertisements delivery terminals.

Another object of the present invention is to provide an eye catching and direct method for user to contact advertiser for feedbacks or request customer services through advertisements delivery terminals.

Another object of the present invention is to provide a method enabling services of an advertiser to hop around the internet, wherever an advertisement can be shown, the services are provided.

Another object of the present invention is to provide an eye catching and direct method for user to send advertisement related information to another person via different media.

Another object of the present invention is to provide a method for advertiser to provide reliable and secure services according to advertiser, publishers and user using online advertisement delivery terminals.

Another object of the present invention is to provide a method which enable advertisers to conduct survey via advertisement delivery terminals.

Another object of the present invention is to provide a method which enable advertisers to distribute coupons, rebate forms through advertisement delivery terminals.

Another object of the present invention is to provide a method to provide sophisticated services via advertisement delivery terminals without the need of modifying the advertisement.

Still another object of the present invention is to provide a method enabling advertisers to provide different services dynamically according to different conditions.

In accordance, the method of the present invention can provide solutions to the problems described in scenarios above. In scenario 1, using the method of the present invention, user C can contact advertiser directly via the advertisement. And the most important, user C can express his opinion in an organized and solicited way, the advertiser can provide feedbacks if necessary.

In scenario 2, using the method of the present invention, company can create and conduct surveys directly along with their advertisement in order to take advantage of the advertisement delivery terminals' penetration ability. The advertiser can promote their company's products and services, and also can obtain useful and valuable information from user. The users can also express their opinions and further have better impressions to the advertisers' businesses.

In scenario 3, advertiser can promote the company as usual, and in addition, they can distribute coupons, rebates, flyers, and other business related information using the advertisement terminals. With the present invention, company does not have to list their coupons on coupon sites, or passively waiting for consumers to visit their site and found out new coupon offerings.

Yet another object of the present invention is to provide a method enabling advertisers to collect data from user when the advertiser has no direct access to. For example, the advertiser is using a SMS advertising provider to send SMS advertisement to cell phone users. Since the advertiser cannot communicate to the user directly, the user cannot communicate with the advertiser directly. With the method of the present invention, the advertiser can provide services via the SMS advertising provider. If the user wants to contact the advertiser, they can use the services advertised along with the advertisement and submit data to the SMS advertising provider. The advertiser can then obtain collected data from the SMS advertising provider.

Still another but not last object of the present invention is to provide a method enable advertisers to demonstrate their products and services via advertisement delivery terminals. A match making company can shows newest members' pictures while a software company can show screen shots of their product along with their advertisements. If the company manufactures web based software, they can even show their demo along with advertisement to enhance the result of advertising.

With the present invention, advertiser can advertise the same ways as before (providing nice visual or audio content etc.) and in additional having the options to provide additional services through advertisement delivery terminals.

Further objects and advantages of the present invention will become apparent from a consideration of the drawings and ensuing description.

### BACKGROUND OF INVENTION—SUMMARY OF INVENTION

The method of the present invention comprising: a service that associates with one or more allowing advertisers to provide services to ad viewer or users. The services that can be provided by advertiser to users including: customer services, advertisement handling, conducting survey, coupon and rebate distribution, and other services (forum, chatting console, photo, product demonstration etc.). The services are independent to the advertisement, whereby allows advertiser to have an option to use the method of the present invention without modifying their existing advertisement and enhance security.

### DRAWINGS

FIG. 1 A shows a block diagram of the advertisement delivery network

FIG. 1B shows an exemplary function block diagram of the service

FIG. 2A-2L illustrate exemplary location of the services associate with advertisements (not in scale)

FIG. 3 shows exemplary forms of service icons

FIG. 4 shows exemplary forms of service interfaces

FIG. 5 illustrates exemplary steps of the service initiation process

FIG. 6 illustrates exemplary steps of the service process

FIG. 7 illustrates an exemplary service interface of the contact service

FIG. 8 illustrates an exemplary service interface of the transfer service

FIG. 9 illustrates an exemplary service interface of the transfer service

FIG. 10 illustrates an exemplary service interface of the coupon service

FIG. 11A-11C illustrates the use of service interface with pop-up window

FIG. 12A-12C illustrates the use of service interface with in-ad configuration

FIG. 13 illustrates an exemplary service setup interface

### DETAILED DESCRIPTION OF THE PREFERRED EMBODIMENT

A detailed description of an exemplary and preferred embodiment of the present invention will now be described with reference to figures. Although this description provides detailed examples of possible implementations of the present invention, it should be noted that these details are intended to be exemplary and in no way delimit the scope of the invention. A person skilled in the relevant art will recognize that other components and configurations may be used without parting from the spirit and scope of the invention.

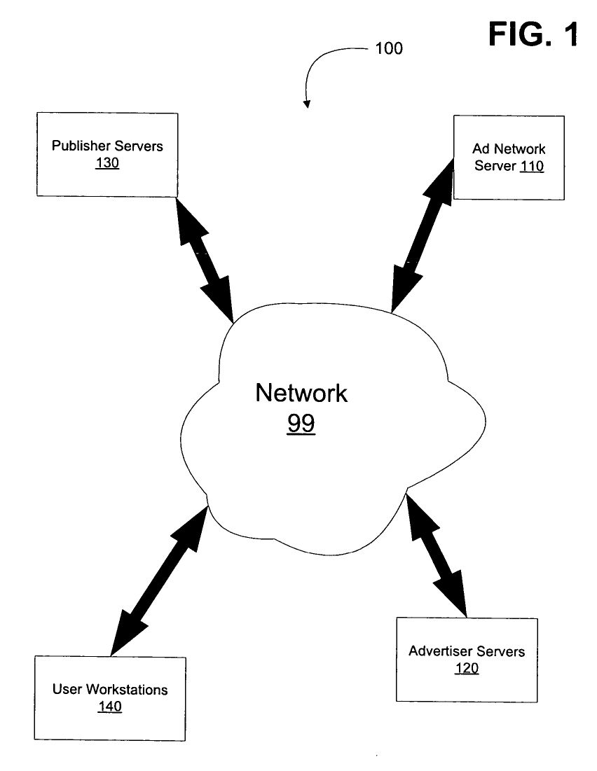

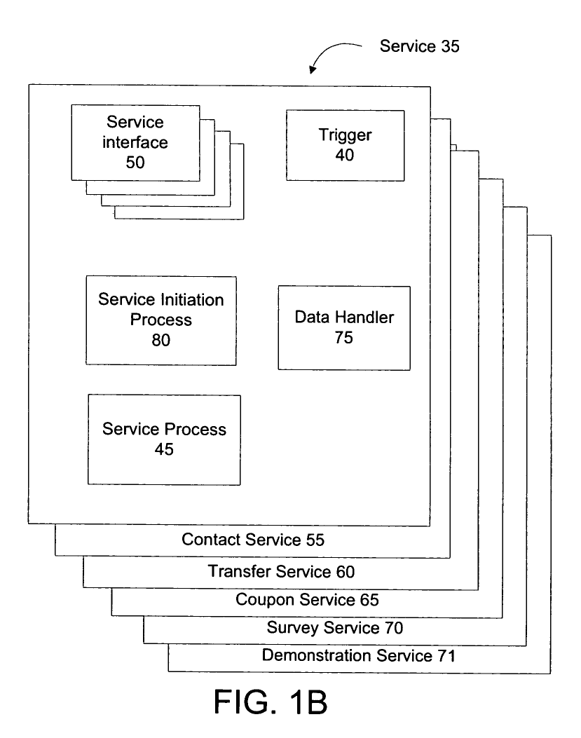

The preferred embodiment of the present invention uses the method of the present invention in an advertisement delivery network 100. Historically, the advertisement delivery network is an organization charged with the representation of advertising space for a group of Webster for the purpose of maximizing revenue and minimizing administrative costs through aggregation. The role of an Internet advertising network is to transact, serve, track and report the distribution of creative from advertisers to publishers using an efficient, interactive marketplace. FIG. 1A shows an exemplary block diagram of the advertisement delivery network 100. As shown in FIG. 1A, the advertisement delivery network 100 includes an ad network server 110, a plurality of advertiser servers 120, a plurality of publisher servers 130, and a plurality of user workstations 140 where services related data can be sent electronically via a network 99. It is understood that the network 99 includes the Internet, intranet, extranet, and wireless cellular network. The advertisement delivery network may include other data servers to provide additional data to the ad network server 110.

Generally, a publisher server 130 is an entity that permits third party advertisements to be displayed via advertisement terminals. In general, publisher servers 130 refer to any display media where advertisements can be sent and delivered electronically via network 99. The exemplary preferred description of the present invention uses a web page ad banner setting that is very common in advertisement networks. That is, a publisher is a web site that allows third party advertisement banners to be displayed via its web site in the description.

When user workstation 140, through a web-browser interface, downloads a web page from publisher server 130, an advertisement (“ad”) 30 is overlaid onto the display of the publisher server 130's web page. It should be noted that the advertisement 30 can be provided directly by the ad network server 110, or the advertiser server 120, or can be provided by another ad server (not shown) that receives an ad request that has been redirected by ad network server 110. The user workstation 140 includes electronic billboard displays, interactive television and monitors or digital display devices, or loud speaker systems, large screen displays, projection and movie screens etc. The user workstation 140 generally includes input devices that are associated with the display media allowing user to input data.

In the following description, the term advertiser server is used to refer to any source of advertising content, whether or not the source of advertising content was the original recipient of an advertising content request. After the ad is displayed on a reserved portion of the publisher's web page, the user can connect to advertiser server 120 by clicking through or otherwise selecting the advertisement (e.g., image, icon, etc.).

In the preferred embodiment, the operation of advertisement delivery network 100 begins when user workstation 140 contacts publisher server 130 by generating a hypertext transfer protocol (HTTP) message to get the information for the desired web page. Publisher server 130 then responds by transmitting web page information, such as a compilation of hypertext markup language (HTML) code, JavaScript, Java applets, graphic image files (e.g., GIF, JPEG), etc., that is used by user workstation 140 in rendering the requested web page in the user's web browser interface.

As part of this compilation of web page information, publisher server 130 also sends a tag (e.g., applet tag) that identifies the source of the ad 30. Using the received tag, user workstation 140 can then send a message to ad network server 110 to request the ad to be inserted into the web page. As noted above, this request may be redirected to yet another third party ad server. As part of this ad request, the publisher server 130 can also send information, such as information that identifies the web site, location in the web site, location in the web page where the advertisement is to be displayed, user identification, etc., that ad network server 110 can use to determine which ad to send to publisher server 130.

Upon receiving the request by user workstation 140, ad network server 110 determines which advertisement to provide to user workstation 140. Once identified, the advertisement 30 data is transmitted to the publisher server 130. The publisher server 130 modifies or rewrites its HTML code to reference the advertisement 30 data. The modified HTML code is served to the user workstation 140 with the properly identified advertisement information. In the preferred embodiment of the present invention, advertisement data include data relates to a service trigger 40. Data relates to the service trigger 40 include trigger data, location of trigger etc.

The ad 30 is not limited to any format, size, or presentation method. The ad 30 can be an image file, a java script, a simple hypertext link, a video file, an audio file, or a flash file etc. that can be displayed via electronic terminals.

The ad network server 110 can be configured as part of the advertiser server 120, or part of the publisher server 130.

Network 99 may be a wired network, wireless network, or a combination of both. In the wireless environment, the publisher server 130 may be a wireless video billboard, a WAP page. The user workstation 140 may be a cell phone, a laptop with wireless connection, a PDA, a wireless electronic touch screen billboard, or any other wireless networking devices that is communicable with the ad network service 110.

Using the above components, the present invention provides a system to allow advertisers to provide services as an additional component to their traditional advertisements in advertisement delivery network.

The Service

In the preferred embodiment, the method of the present invention comprises of the advertisement 30 and a service 35 that can be integrated with any electronic advertisement using any advertising methods. The service 35 allows user to input information to advertisers directly and obtain additional information without active involvement of advertiser server 120. FIG. 1B shows an exemplary block diagram of the service 30. The service 35 comprises one or more service triggers 40, and one or more service interfaces 50. A service initiation process 80 initiates the service 35 when the server trigger 40 is fired by a trigger event 41. A service process 45 processes the steps and functions of the service 35. The service trigger 40 is a trigger to activate the service initiation process 80; the trigger 40 may be in many different forms. The Service interfaces 50 is the user interfaces of the service 35. The service 35 is generally independent of the ad 30, it is an external component that can be added along with ad 30, or a standalone component that functions the same way regardless to the presence or involvement of ad 30.

There are different types of the service 35, it includes: a contact Service 55, a Transfer Service 60, a Survey Service 65, a Coupon/Rebate Service 70, a demonstration service 71, a combination of at least two services 55-71, and other services with other specific purposes. A Data Handler 75 processes the collected data within the service process 45 according to the associate service 35.

In the preferred embodiment, the service 35 is provided by the ad network server 110. The ad network server 110 may provide addition validation to make sure all information sent to publisher server 130 is not harmful to the publisher server 130, user workstation 140, and other servers. The object of providing reliable and secure services according to advertiser, publishers and user using online advertisement delivery terminals is achieved here. Privacy is ensured if the service functions and software are provided by the ad network server 110 because the ad network server 110 can filter out user information before sending data obtained from the services 35 to the advertiser server 120. For example, if the advertiser server is accepting comments using the service 35, the ad network server 110 may send the user information to the advertiser server 120 according to user preference; this can ensure privacy and security.

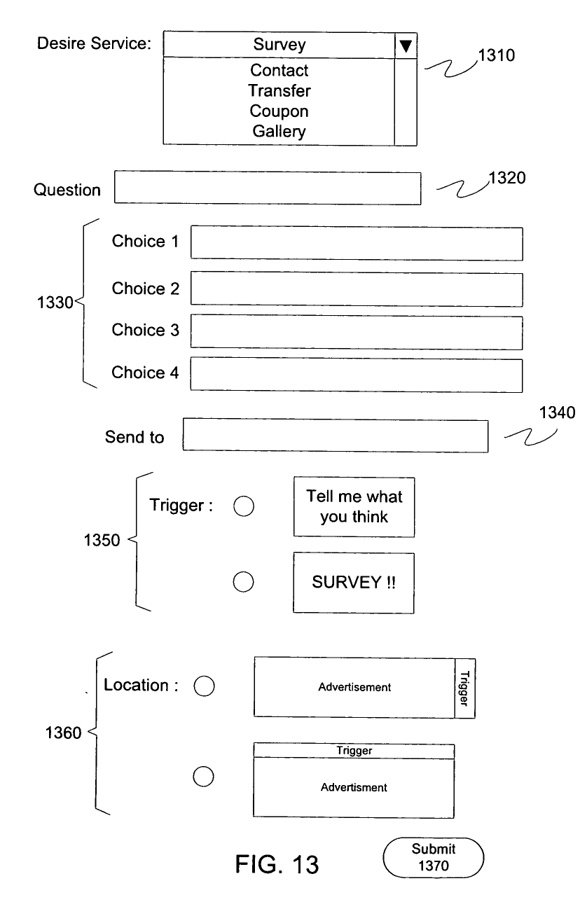

In addition, by providing service 35 data by the ad network server 110 can ensure that no harmful or illegal content is provided through the advertisement. The advertiser can log on to the ad network server and configure the ad network server 110 supplied with service setup interfaces 90 to configure a personal service. Detailed description of configuring a customized service using service setup interface 90 is discussed in FIG. 13.

In an alternative embodiment, service 35 related information and the service 35 itself is provided by the publisher server 130, advertiser server 120, a third party server that supplies service 35 services, or a combination of the above.

Service Trigger

In the preferred embodiment, the service trigger 40 associates with ad 30. The trigger 40 has a one to one relationship with the ad 30. In one embodiment, the trigger 40 has a many to many relationship with the ad 30. The service trigger 40 attaches to the ad 30, when the trigger 40 is triggered by the trigger event 41, the service initiation process 80 starts. Exemplary trigger events 41 could include activate a senor or entering a new address in a dialogue box, load, unload, click, resize, submit, focus, blur, drag, key press (including a mouse button key), select, change (contents of a field), refresh, open, close, redirect, enter, exit, maximize, end of program, beginning of program, beginning of session, end of session, “switching services,” or change of service. Still other trigger events may be time controlled. These trigger events are meant to be exemplary.

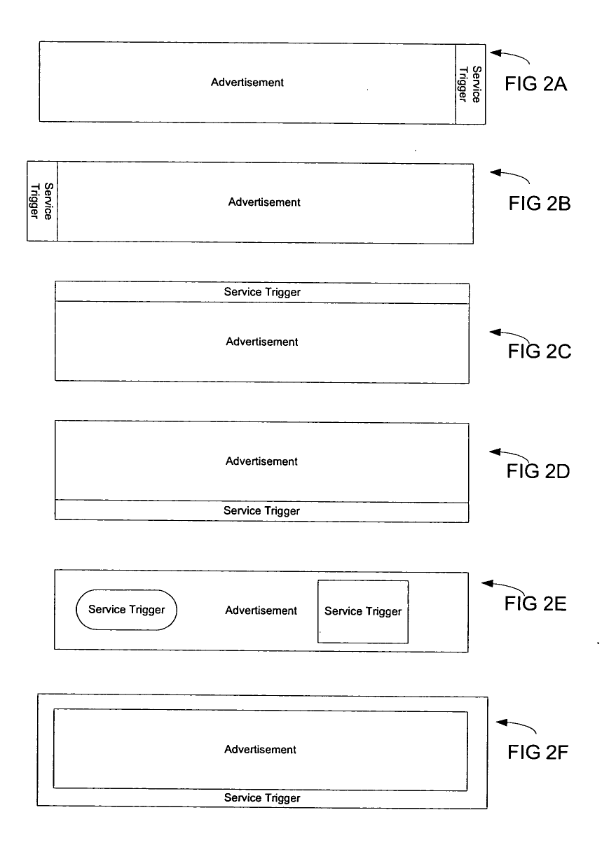

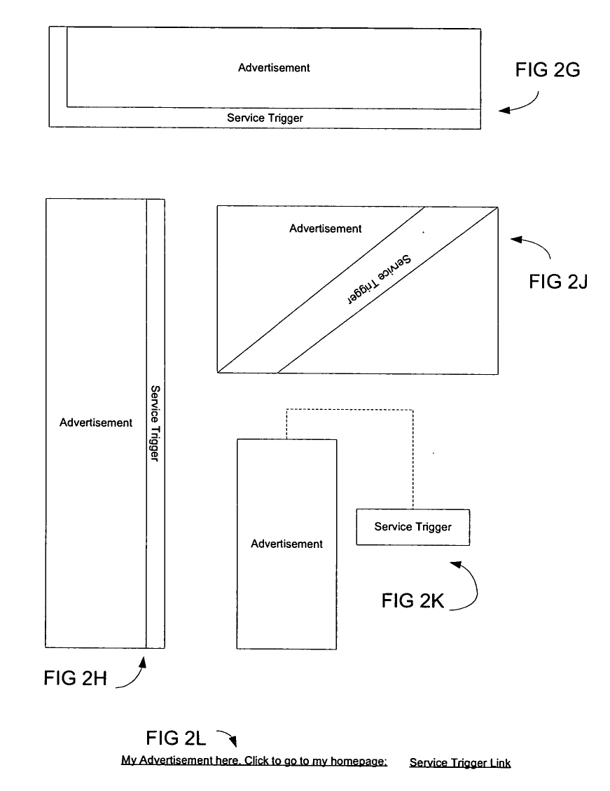

FIG. 2A-2L illustrate exemplary locations of the services triggers 40 in reference to the advertisement 30, the dimensions of the ad 30 are not in scale. The figures show only the reference positions of exemplary service location related to ad 30.

The service triggers 40 can be attached adjacently to the ads 30 as shown in FIG. 2A-2D, 2H. The dimensions of the service are not restricted by the dimensions of the advertisement 30. The width and length of the advertisement shown in the figures are not in scale. The width of the ad shown in FIG. 2A can be smaller than the length of the ad. In the preferred embodiment, the ad 30 may be in many different forms, shapes, and dimensions such as in page formats (Medium Rectangle, skyscraper, leaderboard, banner etc.) and window formats (interstitial, pop-up, pop-under, invue etc.). Referring back to FIG. 2A-2D, and 2H, the service triggers 40 attach to the sides of the ad 30.

FIG. 2E and FIG. 2J shows that trigger 40 can be override, integrated, or embedded as part of the advertisement 30. FIG. 2F an FIG. 2G shows that trigger 40 may attach to more than one side of an advertisement.

FIG. 2K shows that the service trigger 40 does not have to attach to the ad 30, these two components can be separated and located in different locations, as long as it is clear enough for user to distinguish which ad 30 associates with which services triggers 40. The dotted line in FIG. 2K shows the relationship between the trigger 40 and the ad 30.

FIG. 2L shows a text based ad that can be represented by a simple hypertext link. The trigger 40 is also in text form that triggers the service process 45, and further activate the service 35 with a click on the text area.

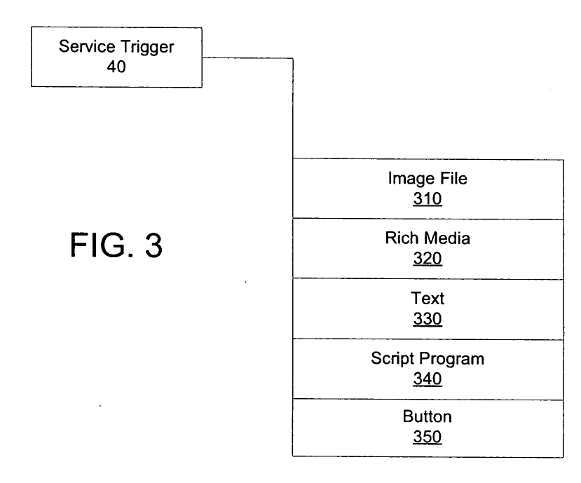

Now referring to FIG. 3, it shows exemplary forms of trigger 40 that may be used in the present invention. In the preferred embodiment, the service trigger 40 is an Image File 310, a Rich Media 320, text 330, a script program 340, or a button 350. These service triggers 40 are meant to be exemplary.

The image file 310 maybe a GIF, JPEG, BMP or any other image file format that can be rendered and display at user workstations 140. The image file 310 includes an image link or an image button, and by clicking the mouse when the mouse pointer is over the image can trigger the service initiation process 80. For example,

<form runat=”server”>
<a href=” http://www.advertiser.net” ><asp:Image id=″Advertisement″

ImageUrl=″advertisement.jpg″/></a>

<asp:ImageButton id=″Services_trigger″ ImageUrl=″Trigger.jpg″

CommandName=″ServiceA_function″ />

</form>

The rich media trigger 320 is a rich media file or program that can be rendered at user workstation 140. The rich media 320 includes a Flash file, designed and compiled using Macromedia Flash MX, manufactured by Macromedia Inc.

Text 330 may be used as the way shown in FIG. 2L. It is a pure text service trigger, in general text 330 is a hypertext link that is best fit to a text based advertisement. Example of text based advertisement is Google AdWords, provided by Google Inc.

The service trigger 40 may be the script program 340. The script program 340 is a programming script such as java script that is associated with ad 30. When the ad 30 is rendered to the user workstation 140, the script program is run. Example of script program is a client side java script that renders a graphical icon/image file floats in random direction on a web page. The graphical icon/image file is clickable, and further to activate the service. The script that renders floating ads is an example of the script program 340.

Another type of service trigger 40 shown in FIG. 3 is the button 350. The button 350 is just a normal html button that can be selected and activate the service 35 by a simple click, or keystroke.

In an alternative embodiment, the advertisement 30 is also used as the service trigger 40. For example, user can activate the service or start the service initiation process 80 using the mouseover event, and forward to the advertiser's web site by a click. For example, the ad 30 is configured to forward to the advertiser's web site when the user click within the ad 30. In addition, the ad 30 is configured to activate service 35 when the mouse is moved over to the advertisement and idle for a predetermined period of time. In such cases, the ad 30 is also the service trigger 40 despite what format the ad 30 is in.

Service Interface

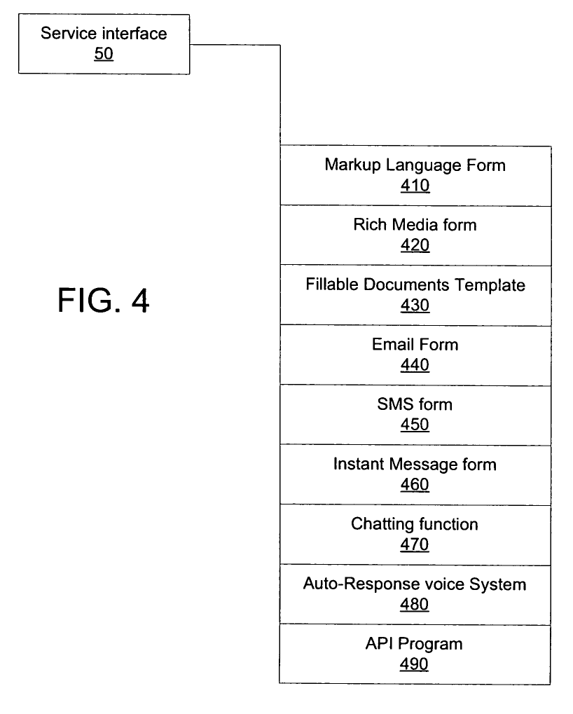

Now referring to FIG. 4, it shows exemplary forms and types of the service interface 50. The service interfaces 50 are selected from a group including a markup language form 410, a rich media form 420, a fillable documents template 430, an email form 440, a SMS form 450, an instant message form 460, a chatting console 470, an auto response audio system 480, and an API 490. Interfaces 410-460 are form based interface, while interfaces 470-490 are not. The service 35 may have more than one service interfaces 50.

The service interface 50 is the user interface of the service 50 that a user uses to interact and input data to the advertiser server 120, publisher server 130 or ad network server 110. When the service trigger 40 is triggered, the service initiation process 80 starts. The service initiation process 80 obtains information related to the service 35 and renders the information in the form of the interfaces 50. In the preferred embodiment, the service interface 50 is a markup language form 410 written in markup languages. A HTML form that can be rendered in a web browser at the user workstation 140 is an example of markup language form 410. The service 35 may comprises of more than one service interfaces 50.

The interface 50 may be the rich media form 420. The rich media form 420 is a form that is in rich media format. An example of the rich media 420 is a flash form that is designed and compiled using Macromedia Flash MX, manufactured by Macromedia Inc. The rich media 420 form is a rich media file that contains functions to accept user inputs and data submission.

The interface 50 may also be the fillable document template 430. An example of fillable document 430 is a fillable PDF document designed with Adobe Acrobat, manufactured by Adobe Inc. Another example of fillable document 430 is a Microsoft Excel Spreadsheet that allows user to fill in information and has a macro enabling user to submit the information.

The interface 50 may be the email form 440. The email form 440 is very similar to fillable document 430. One of the different is to that the form is open in an email client and ready to be sent. The subject, receiver and other email related information are pre-filled. In general, the email form 440 is a ready to send email that pre filled with some headings, and allows user to fill in the blanks. After the user is done, user can simply send the email out via the email client. An example of email form 440 is an electronic file with extension EML.

Two other forms of the interface 50 are the SMS form 450 and the instant message form 460. The form 450 and 460 works similar to the email form 440, but they are loaded by using SMS function and instant messaging client respectively. The form 450 is loaded in a SMS messaging client, while the form 460 is loaded in instant messaging client such as ICQ, MSN Messenger, AOL Instant Messenger. The forms 450-460 allow user to fill in some blanks and then send it out through the associated clients.

The interface 50 maybe non form based interfaces. The chatting console 470 is an example of such interface 50 that allows user to chat with another entity. A web based java script chatting module may be used as the chatting console 470. In general, the chatting console is hosted at the ad network server to ensure security. In one embodiment, the chatting console may be hosted at the advertiser server 120. When the service 35 is triggered, a chatting program or java function is loaded and user can chat with other people. The people joining the chatting console may be people from advertiser network 120, ad network server 110, or other users.

The interface 50 can be configured as the auto response audio system 480. The system 480 is an audio interface that may be deliver using audio speakers and a microphone of the user workstation 140, or connected to a phone that is communicable with the user workstation 140. The user input information using the phone, to record a message, or the touch tone keys to make selections and input data.

The interface 50 may be the API program 490. The service process 45 initiates a program that comprises of the API 490 resided at user workstation 140. The API program 490 contains functions to communicate with ad network server 1 10, or other servers via the program 490.

In one embodiment of the present invention, the service 35 does not have interface 50. If the service performs simple task such as bookmarking a web site that contains the ad 30, then there is no need to have the interface 50.

Service Initiation Process

The service 35 comprises of the service trigger 40 and one or more service interfaces 50. The service trigger 40 is a switch to activate the service, user uses the trigger 40 to open up the service 35. The interface 50 is a visual, audio, or both interfaces of the service, the interface 50 is the user interface for accepting user inputs. When the trigger 40 is triggered by the trigger event, the service initiation process 80 starts.

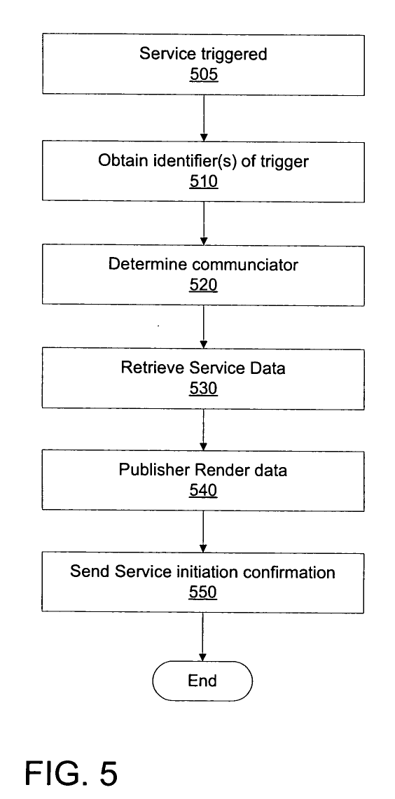

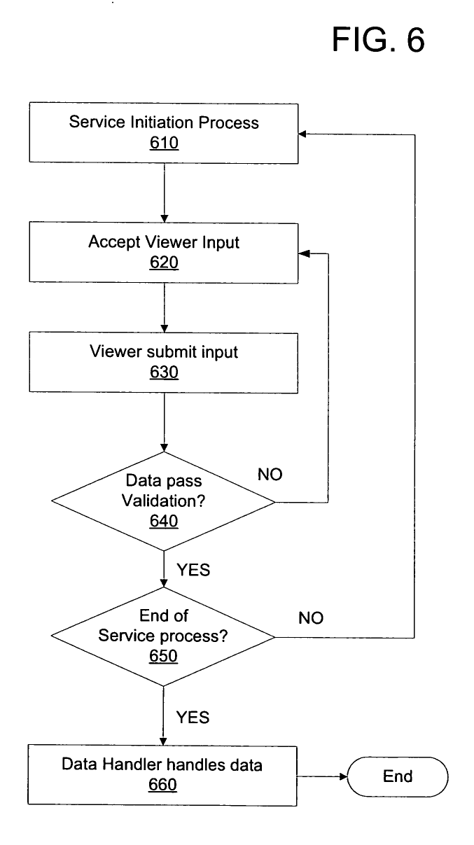

FIG. 5 illustrates exemplary steps of the service initiation process 80. At step 505, the service initiation process 80 starts in response to the trigger event 41. The trigger 40 can be triggered in different ways.

At step 510, the process 80 obtains the identifier of the trigger 40 from the ad network server 110. The identifier indicates which service the triggered trigger 40 is associated to. In the preferred embodiment, the trigger 40 has a one to one relationship with the ad 30, therefore the identifier of the ad 30 can be also be the identifier for the trigger 40. The identifier may be a single value or a group of different identifiers.

At step 520, the service initiation process 80 determines which service to load and customized configurations of the service 35 according to the identifiers obtained at step 510. In one embodiment, to which service 35 to be loaded is depending on a number of factors; and the identifier is only one of the factors.

At step 530, the process 80 retrieves service 35 related data from various sources including the ad network server 1 10, the advertiser server, and other sources. The service related data includes data related to service interface 50, service process 45, type of service 35, requirements of service interfaces etc. In the preferred embodiment, the service 35 data are supplied by the ad network server 110 for security reason. Therefore, the ad network server 110 is able to validate the codes of the service 30 before transmitting them to the publisher server 130. It is because it can be very dangerous for the publisher servers 130 to insert any code that are transmitted from the advertiser servers 120. In an alternative preferred embodiment, the service 35 data are provided by the advertiser server 120 or third party servers for complicated functions that are not possible to be supported by the ad network server 110.

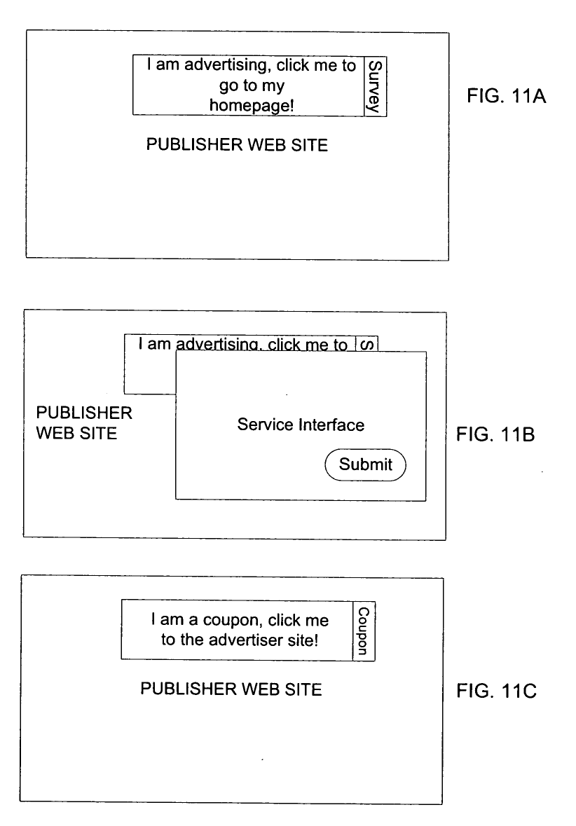

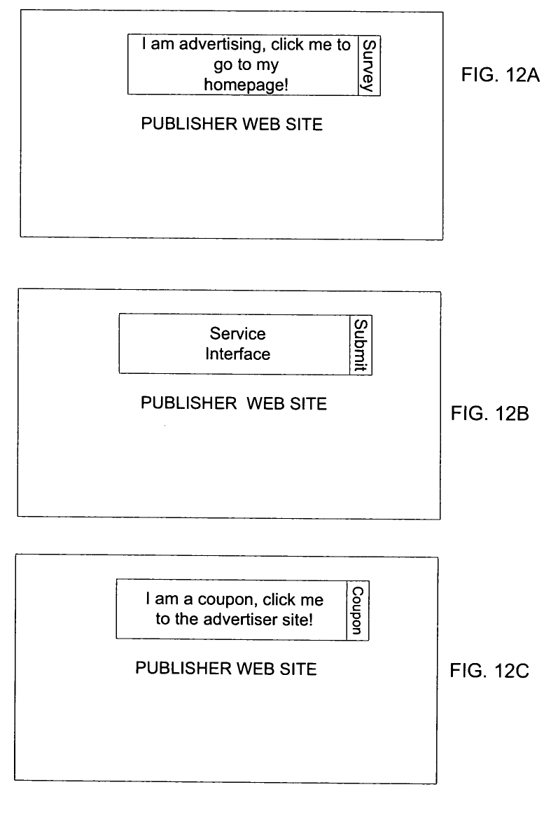

At step 540, service data obtained at step 530 is transmitted to user workstation 140 and rendered by user workstation 140 in the web browser interface. In the preferred embodiment, the initiation process 80 open a new web browser window and loads up the service interface 50. The service interface 50 is rendered in the new web browser windows, with data and information related to the ad 30 according to the service 35. In one embodiment, the service interface 50 is rendered to replace the ad 30 in the user workstation 140 web browsers. Method of use will be discussed in FIGS. 11 and 12.

At step 550, a service initiation confirmation is sent to the service data sources indicating the succession of the service initiation process 550.

Service Process

After the service initiation process finishes at step 610, the service 35 is loaded and the service process 45 starts. At step 620, the service process 45 accepts user inputs through the service interface 50. In the preferred embodiment, service interface 50 is a HTML web form which allows users to enter data.

At step 630, user submits input data. User can submit a data by certain actions such as clicking on a HTML button, a hypertext link, or closing the pop-up web browser. At step 640, the process 45 validates the data input data from step 630. If the input data are invalid, process 45 notifies user and ask user to re enter the data. If the input data are valid, the service process 45 continues to step 650.

At step 650, the process 45 checks whether the user has finished inputting all data or the whole service process 45. The process 45 determines if the service process should end or continue with another process such as recursively starting another service 35. Another service 35 starts if the user recursively calls another service within one service. It means that an additional trigger 40 is loaded within the interface 50. If the process 45 determines that the user finishes using the service, the process 45 continues at step 660.

At step 660, the data handler 75 processes the collected data collected from the user. The data handler 75 performs all necessary actions that are required to process the data according to the service 35. The necessary actions that are required to be performed by the handler 75 includes: sending the collected to advertiser using media such as email, ICQ, or SMS etc., submitting survey data to advertiser using API functions, sending ad 30 as attachment to other entities, and handling coupons/rebates as requested etc. In general, data handler 75 is a function that processes the data according to the associated service 35. The current process 45 ends after the data handler 75 handles the data, the process may return the control to a parent service 35 if it is called recursively. In one embodiment, the process 45 may load up another interface 50 instead of exiting the process 45.

In the embodiment that no interface 50 is associated with the service 35, the service process 45 is not used as well. It is because the service initiation process 80 can finishes the tasks of the service 35 without waiting for user input.

Contact Service

There are different types of service 35, the service 35 may includes one or more: the contact Service 55, the Transfer Service 60, the Survey Service 65, and the Coupon Service 70, the demonstration service 71, or a combination of the services 55-71.

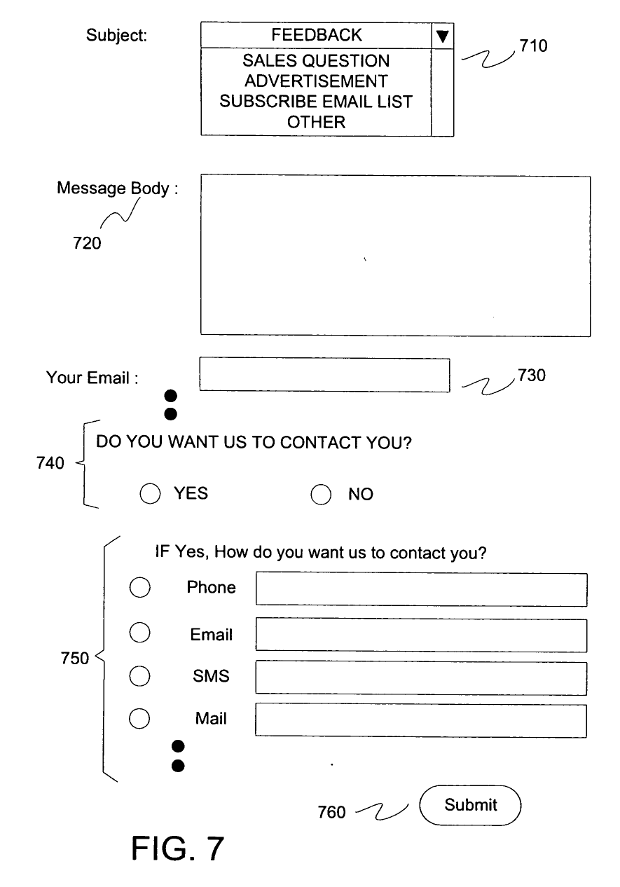

FIG. 7 shows an exemplary service interface 50 of the contact service 55. The contact service 55 allows user to contact advertiser server 120, and send services request to advertisers. In the preferred embodiment, the contact service 55 is a HTML form that allow user to send an email to a predetermined email address that belongs to the advertiser server 120.

User can select from a list of predetermined email subject from a drop down box 710. User enters in a text field 720 the information that the user wants to inform the advertiser or the advertiser server 120. A text field 730 is used to enter an email address of the user. A radio button list 740 may give user the options whether he/she wants to be contacted by the advertiser or advertiser server 120. User can also use a contact option list 750 to tell related parties which methods can be used to contact the user if the radio button list 740 is chosen yes. After entering data, the user uses a submit button 760 to submit the information. When the button 760 is clicked, the data handler 75 of the service process 45 of the contact service 55 runs and processes any necessary functions. In the preferred embodiment, the data handler 75 of the contact service 55 assembles all the entered information into an email and sends it to a predetermined email address of advertiser server 120.

Transfer Service

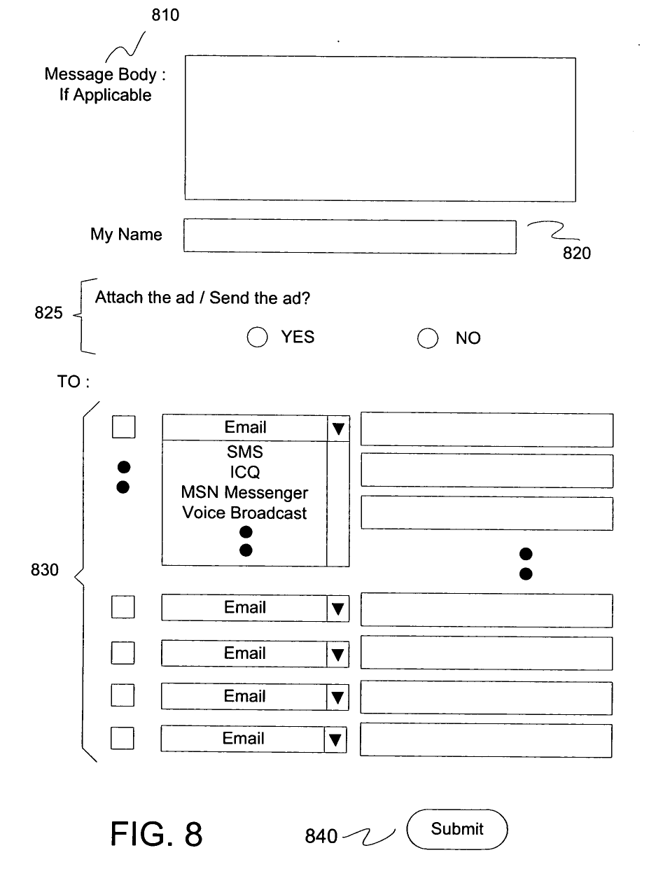

FIG. 8 shows an exemplary service interface 50 of the transfer service 60. The transfer service 60 allows the user to inform other person about the ad 30, the user can enter a message in a text box 810 to the receivers, and the receiver can be the sender himself/herself. The user may also type in his/her own name in a text box 820, if the user wants to let the receivers to know who the sender is.

The user chooses whether to send the ad 30 as attachment or the link to the receivers using a radio button list 825. The user uses a receiver option form 830 to enter receiver's contact information. The user chooses from a list of services media such as email, voice recording broadcast, instant message, and SMS etc. Button 840 is the submission button of the transfer service 60. The sender can be the receiver as well if he/she wants to have a record of the ad 30 in certain form. When the button 840 of the transfer service 60 is clicked, the transfer service data handler 75 starts and handles the data. In the exemplary service 35 of the transfer service 60 shown in FIG. 8, the data handler 75 assemble the data collected from the interface 50 in FIG. 8 into different message format according to user preference in the receiver option form 830.

For example, if the user is trying to use the service 35 to send a certain ad to a receiver using email, the handler 75 then uses predetermined SMTP server configuration to send an email with the ad 30 attached, or if the user tries to send the information via SMS, data handler then send the link of the ad 30 using a SMS API function. The service 35 may have sub services 35 inside it, the submit button 840 may start another service initiation process 80 instead of calling the data handler 75 as shown at step 650.

Survey Service

The survey service 65 allows advertiser to conduct surveys, polls, or questionnaires along with advertisement or independently via advertisement terminals. User starts the survey service 65 by firing the service trigger 40. After the service initiation process 54 of the survey service 65 finishes, the service interface 50 of the survey service 65 is shown to user.

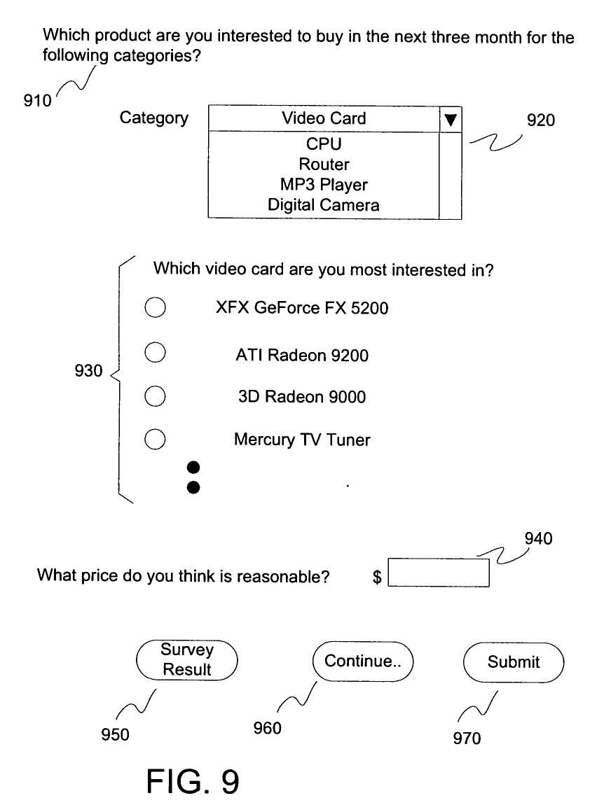

Referring to FIG. 9, it shows an exemplary interface 50 of the survey service 65. A question 910 tells user what the survey is about. User chooses the product category from a drop down list 920. The selection of the drop down list 920 loads up question and choices 930 according to the selected category. The user uses a text box 940 to enter a reasonable price according to the user. The survey service 65 may contains one or more questions 910, drop down lists 920, questions and choices 930, and text boxes 940.

A button 950 may be used to show updated survey result to the user. The service process 45 loads up a pop-up window and shows the updated results using a pie or bar graph. A button 960 may be used to continue with another survey or poll. The service 35 may have more than one service interfaces 50. User can submit the input data using button 970. The button 970 calls the handler 75 of survey service 65 to handle the survey or poll data. Generally, the handler 75 of service 65 inserts the data collected by the service 65 into a database.

Coupon service

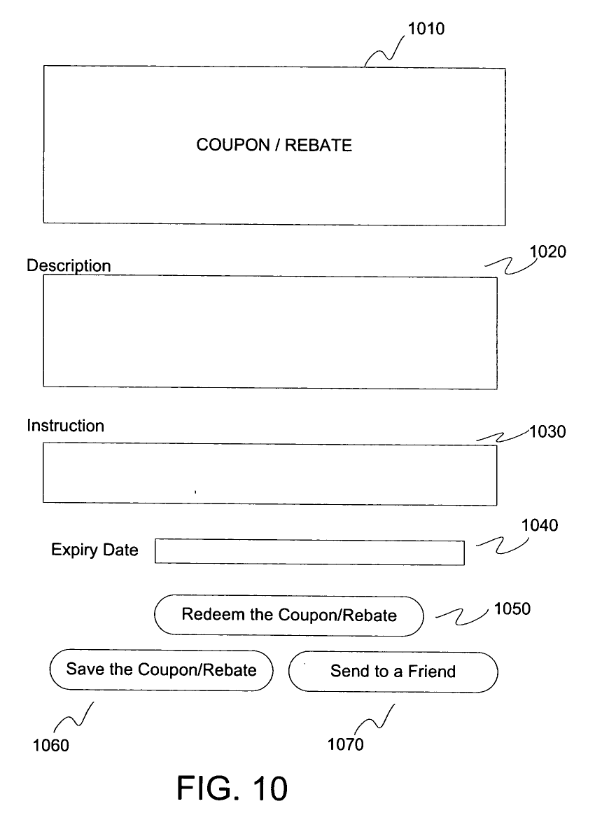

The coupon service 70 is used when the advertiser wants to distribute coupon, rebate, and rain checks via advertisement terminals. User starts the coupon service 70 by triggering the trigger 40. The service initiation process 80 of the coupon service 70 loads up the service interface 50 of the coupon service 70. FIG. 10 shows an exemplary interface diagram of coupon service 70's interface.

A coupon image 1010 shows the related coupon of the associate service 35. The coupon image 1010 may be an image file, rich media file, or in simple text format. The description of the coupon is shown in a description area 1020. The description may include the type of product of the item associated with the coupon, configuration, and manufacturer information. An instruction area 1030 shows coupon usage instruction such as date limitation, method of redeeming the coupon, and restrictions etc. An expiry date area 1040 shows the expiry date of the coupon.

After considering the coupon data, user can redeem the coupon or the rebate by using a redeem button 1050. After clicking the redeem button, the user is forwarded to an advertiser's site to buy the product there, or directly to the check out pages. In one embodiment, user may buy the product directly in the service 35. User use a save button 1060 to save the coupon for later use, methods of saving a coupon include bookmarking the ad 30 or the coupon, saving the coupon to the memory of user workstation 140 etc. The user may also use send button 1070 to send the coupon to a friend. After clicking on the send button 1070, a pop up windows is brought up. In one embodiment, the send button 1070 triggers the transfer service 60 and allows user to send the coupon to other entities using service 60. The coupon service 70 is not limited to distribute coupon only, it may be used to distribute rebates, rain checks, and flyers etc.

Method of Use

FIG. 11A-11C shows an exemplary method of use of the present invention. FIG. 11A shows a web browser at user workstation 140, the publisher web site and the ad 30 is rendered in the web browser. The service trigger 40 of the service 35 according to the ad 30 is also rendered along with the ad 30. The user can surf the publisher web site, click on the ad to go to the advertiser web site, or click on the trigger 40 that says “SURVEY” to initiate the service initiation process 80.

When the user clicks on the trigger 40, the service initiation process 80 starts and retrieves service 35 information. The service initiation process 80 renders the service interface information into a pop up window as shown in FIG. 11B. The service process 45 starts after the initiation process 80 finishes. The user enters information to the interface, and click on the submit button to indicate end of service process 45.

FIG. 11C shows screen shot of user workstation 140 after the service process 45 ends. The pop up window closes and user can return to publisher web site without leaving. The web browser at user workstation 140 may reload the ad 30, or continue with another ad 30.

Alternative Method of Use

FIG. 12A-12C shows an alternative preferred method of use of the present invention. FIG. 12A is the same as FIG. 11A, it shows a web browser at user workstation 140, the publisher web site and the ad 30 is rendered in the web browser. The service trigger 40 of the service 35 according to the ad 30 is also rendered along with the ad 30. The user can surf the publisher web site, click on the ad to go to the advertiser web site, or click on the trigger 40 that says “SURVEY” to initiate the service initiation process 80.

When the user clicks on the trigger 40 (“survey” button), the service initiation process 80 starts and retrieves service 35 information. The service initiation process 80 replaces the slot occupied by the ad 30 with the service interfaces. The service 35 is independent of the ad 30, therefore, the web browser is actually re-rendering the slot to load the interface 50. Unlike other method that interaction functions are embedded inside the advertisement, the service 35 of the present invention can be removed from the ad delivery without affecting the performance of the ad. The method of the present invention has an advantage that allows advertisers to change marketing strategies frequently without re-designing the ad 30. In addition, the service 35 provides advertisers the flexibilities that no prior art provides.

In the preferred embodiment, which is in an advertisement delivery network configuration, the advertisers only have to supply an ad 30, and the service can be provided by the ad network server 110 with minimal steps.

In the alternative method of use of the preferred embodiment, user submits data using the submit button to submit the data. FIG. 11C shows screen shot of user workstation 140 after the service process 45 ends. The ad 30 is now replacing the interface 50 and the web browser returns to original operation. The web browser at user workstation 140 may reload the ad 30, or continue with another new ad 30.

Alternative Service Interface Embodiments

Referring again to FIG. 4, there are two types of service interfaces: form based and non-form based. The preferred embodiment shows an exemplary use of form based interfaces 410-460. Non form based interfaces include chatting console, auto response audio system, and other program that API functions etc. The chatting console interface 460 connects the user to a chatting console and allows the user to chat with other persons, the person include people that works for advertiser to provide real time customer services or other users that also log on to the chatting console.

In the embodiment that the interface 50 is the auto response voice system, the service initiation process 80 initiate an audio output device and an audio input device. The content of the interface is in audio format, and allow the user to record information using the audio input device, or using other input devices. Example content of the interface includes a question asking the user through a speaker, and the user input the answer using a microphone, or a keyboard.

Service Creation

FIG. 13 illustrates an exemplary service setup interface 90. In the preferred embodiment, advertiser can configure the use of the service 35. The interface shown in FIG. 13 may be one of many steps of creating an advertisement campaign at the ad network server 110. For example, the advertisers logs on to the ad network server and creates an new ad campaign by entering information such as the advertisement location, audience targeting information, start date, end date, advertisement resources, and advertisement link etc. The interface shown in FIG. 13 is the one step of a campaign configuration process. At the top of the service setup interface, an option list 1310 is used to select the type of service can be used. By choosing different service, the interface is refreshed to show forms of different services 35. The interface shown in FIG. 13 is the setup interface 90 for a survey service 65.

Advertiser enters the poll question in a text box 1320. A text box list 1330 is used to enter choices for the poll. Advertiser enters the email address in a text box 1340. The data obtained from the survey service 65 are sent to the email address indicated in text box 1340.

Advertiser can choose the appearance of the service trigger 40 from an image list 1350. Advertiser can further choose the location of the service 35 in reference to the ad 30 from an image list 1360. After configuring the survey service 65, the advertiser can save and continue with the ad campaign setup by clicking a submit button 1370.

Additional Services

In the description of the present invention, there are four discussed services 55-70. More service 35 with other options may also be used. For example, a stock ticker service that allows service to check stock prices via service interface. The stock ticker service is useful for financial business who wants to show off their services.

Another possible form based service includes a forum service that accesses a forum that allows user to read other user's comment such as product review, advertiser review, and also allow user to leave comments. Example of advertisers who may use the forum service includes retail business that offers forum functions. Another non form based service is a news service. The service 35 loads the latest news from a database every time the service is triggered. The news service is suitable for a portal or media related advertiser.

Yet another non form based service is a demonstration service 71. The interface 50 of the demonstration service is a product demonstration showing demonstration including images, text, video, audio files, software functions, or a combination of the above related to business of the advertiser. The demonstration service is useful for advertisers who want to show additional information related to products of company related to the advertiser's interests. Example of advertisers that may use the demonstration service includes real estates broker, art demo, dating company etc.

Another example of the demonstration services 71 is a software company showing off the company's product. A company that manufactures online graph reporting software can shows exemplary graph in the service 71. A company that provide smileys and emotions function in email can use service 71 to allow the users to send email via the service interface 50 with the company's smileys and emotions.

A very specific example is using the demonstration service 71 of the present invention along with Google AdSense, an advertising services provided by Google Inc. The service trigger 40 is in the form of text 330 as a hypertext link similar to FIG. 2L. The advertisers using AdSense can configure their demonstration services 71 at the time they configure the demonstration service 71. The advertisers may configure the service 71 to shows screen shots of their software product, pictures of their newest product, an animation that shows off their latest animation creation software, summary of the newest news, or a software demonstration of their product in use. The advertiser can use the method of the present invention bring the user one step closer to something the advertisers wants to show the user the most, it is like a summary of the business.

Method of Requesting and Integrating Services

There are different methods can be used to integrate the advertisement along with the service. Although the existent of the advertisement is not compulsory, however the service 35 of the present invention is preferably accompany with the advertisement 30.

In the preferred embodiment, the ad 30 and service 35 are requested using the same technologies that are used in any other advertising method. If the ad is an in page format, a code segment is inserted to the publisher's web page. When the ad information is transmitted to the publisher server 130, the publisher server modifies or rewrites its HTML code to reference the advertisement 30 served by the ad network server 110. To use the service 35 along with the ad 30, the ad network service just needs to send additional information about the service 35 to the publisher server 130 along with the ad 30 information. An exemplary HTML code fragment for a typical image file based ad and an image based trigger 40 as rewritten by the publisher server 130 is shown below:

<a href=“http://www.advertiser.com/site”>
<IMG src=“http://www.ad.ca/ad.JPG” />
</a>
<a href=“http://www.service.com?id=123”>
<IMG src=“http://www.comor.com/comm1.JPG” /></a>

An exemplary HTML code fragment for a typical video file banner ad as rewritten by the publisher server 130 is shown below:

<a href=“http://www.admethod.net/site”>
<IMG dynsrc=http://www.admethod.net/ad.mpeg border=0 /></a>
<a href=“http://www.service.com?id=123”>
<IMG src=“http://www.comor.com/comm1.JPG” /></a>

An exemplary HTML code fragment for a typical rich media ad as rewritten by the publisher server 130 is shown below:

<object classid=“clsid:D27CDB6E-AE6D-11cf-96B8-444553540000”
codebase=“http://download.macromedia.com/pub/shockwave/cabs/flash/swflash.cab#
version=4,0,2,0>

<param name=quality value=high>
<embed src=“http://www.advertisement.com/ad.swf” quality=high

pluginspage=“http://www.macromedia.com/shockwave/download/index.cgi?P1_Prod

_Version=ShockwaveFlash″ type=″application/x-shockwave-flash″
width=″760″
height=″134″>

</embed>

</object>
<a href=”http://www.service.com?id=123”>
<IMG src=”http://www.comor.com/comm1.JPG” /></a>

The exemplary code fragments shows that the service 35 is independent of the advertisement 30. The service code is added by the publisher server 130 during HTML rewriting according to information obtained from the ad network server 110. If the advertiser requests to use the service 35 along with the ad 30, the ad network server 110 then sends service related data along with ad related data to the publisher server 120 if the ad 30 is chosen to be loaded, so the publisher server can rewrite the code with the service information included. However, if the advertiser does not want to use the service 35 along with its ad 30, the advertiser can simply reconfigure the ad campaign. Then no service related information would be send to the publisher server 120 when the ad 30 is selected to be loaded. The publisher server 120 has no information whether the ad 30 to be loaded use the service 35.

Dynamic Service Usage Embodiment

The publisher server 130 sends an ad request to the ad network server 110 in order to request the ad 30. The ad request may include data related publisher server 130, user workstation 140, and other third party servers. After identifying which ad to be transfer to the publisher server 130, the ad network server 110 may also determine whether to send service 35 related data along with the ad 30. The decision whether to send service 35 information can be depended on a few conditions and factors. The decision is made according to the preference of the advertiser server 120 and data obtained in the ad request. For example, the ad request sent by the publisher server 130 includes some data indicating the publisher server 130 that does not want to have service 35 being used on its pages. The ad network server analyzes the data and understands that no service 35 information is needed. Then the ad network server 110 sends only the ad 30 related data, without sending any service related data.

Another example of dynamic service usage is having more than one services 35 associating with one ad 30, and to which services 35 the publisher server 30 should use depends on certain factors. For example, the advertiser creates an ad campaign and wants to use two services 35 (first service and second service) with the ad. If the ad 30 is shown less than 10 millions times, the ad 30 should be delivered with the first service. If the ad 30 is shown more than 10 millions times, then deliver the ad 30 with the second service.

Yet another example of dynamic usage is that using two different services in turns. If the ad is requested the first time, associate it with the first service; then the next time the ad is requested again, associate it with the second service. The dynamic usage of dynamic service is useful when the advertiser has two different polls or surveys.

There are other methods of using a dynamic service. To which service should be used, or whether to use a service is determined by a series of conditions. If the services 35 are used dynamically, step 520 of the service initiation process 80 is reconfigured to handle the decision making.

No Advertisement Embodiment

In one embodiment of the present invention, there is no ad 30. The service 35 is initiated and started directly as the publisher server 120 rewrites and modifies the HTML codes. In general, ad network server 110 transfer the service 35 data directory to the user workstation 140 and go direct to FIG. 12B by skipping FIG. 12A. In this case, the user does not have to trigger the trigger 40 to start the service initiation process 80. In the no advertisement embodiment, the advertiser can provide services via advertisement channel rather than showing ads. This is useful when an advertiser feels that providing actual services using advertisement delivery channel can obtain better results than simply showing ad using the channel. In general, in the no advertisement embodiment, the service initiation process 80 starts as soon as the advertisement material is transferred to the publisher server 120. In the no advertisement embodiment, the advertiser can even take advantage of the advertisement delivery terminals to promote the business without creating an ad.

Message on Service Trigger

In general, a message on the service trigger 40 showing user what type of service 35 the trigger is related to. Below is a list of exemplary messages that can be used:

Contact Advertiser

Customer Services

Comment

Survey

Poll

Coupon Here!

Rebate

Email to a friend

Discuss with others

Chat with our world class customer services representatives

Add to bookmark!

Which part of President XXX's compassionate conservative agenda is most important to you?

What do you want to see on [politician name]'s agenda?

Which product you want to buy next?

Take a look at our samples

See pictures of our newest members

The message on the trigger 40 helps users to identify the usage of each service 35.

Offline Embodiment

The method of the present invention can be implemented in an offline embodiment. In the offline embodiment, the publisher server 130 is preloaded with advertisements 30 and service 35 data. The publisher server 130 comprises of at least one output device to display the advertisement 30 and service interface 50, and an input device to collect data from user. The data handler 75 stores the collected data locally until further use. For example, an electronic display billboard is accompanied with a touch screen monitor and a processing system in a subway station. The electronic display billboard display advertisements 30, the service trigger 35 is shown on the touch screen monitor. If the user wants to use the service 35, the user can touch on the service trigger 40 on the touch screen monitor and start the service initiation process 80. The service interface is then made available to the user through the touch screen monitor. The user can enter and submit data using the touch screen monitor. The data handler 75 then stores the collected data locally in the processing system for later use.

### CONCLUSION, RAMIFICATIONS, AND SCOPE OF INVENTION

Thus the reader will see that the method of the present invention provides an efficient, intelligent, yet powerful method that can be used by advertisers to provide complicated, efficient and flexible services through advertisement delivery terminals. With the present invention, advertisers can provide customer services, distribute coupons, extend reaches, and conduct surveys along with their advertisements.

Those skilled in the art will recognize that the method and apparatus of the present invention has many applications and that the present invention is not limited to the representative examples disclosed herein. Moreover, the scope of the present invention covers conventionally known variations and modifications to the system components described herein, as would be known by those skilled in the art.

1. A method enabling an advertiser to provide services to users and collect data from said users via an advertisement delivery terminal, said method comprising steps of:
(a) displaying an advertisement in an advertisement display;
(b) displaying one or more service triggers in one or more trigger displays;
(c) and, providing services to said user in response to said service trigger is fired by a trigger event;

2. The method as claimed in claim 1, wherein said advertisement delivery terminal is selected from a group comprising of: (a) an web page related advertisement space; (b) an mobile wireless application protocol page related advertisement space; (c) an audio broadcast advertisement channel; (d) a interactive television advertisement slot; (e) an electronic advertisement billboard; and (f) an offline advertisement electronic display device slot.

3. The method as claimed in claim 1, wherein said service trigger is in a form selected from a group comprising of: (a) an image file; (b) a rich media; (c) a text; (d) a script function; (e) a button; (f) a command; and (g) a combination of at least two of said service trigger forms of (a)-(f).

4. The method as claimed in claim 1, wherein said service interface is selected from a group comprising of: (a) a markup language form; (b) a rich media form; (c) a fillable documents template; (d) an email form; (e) a short message service form; (f) an instant message form; (g) a chatting console; (h) an auto response audio system; (i) an application programming interface; and 0) a combination of at least two of said service interfaces of (a)-(i).

5. The method as claimed in claim 1, wherein said service triggers are integrated as part of said advertisement whereby said advertiser can embed the service trigger into said advertisement to have consistent appearance.

6. The method as claimed in claim 1, wherein said services and said service triggers are independent of said advertisement whereby said service triggers and said service can be removed from said advertisement without affecting performance of said advertisement.

7. The method as claimed in claim 1, wherein said trigger event is selected from a group comprising of: (a) select; (b) moveover; (c) load; (d) unload; (e) click; (f) resize; (g) submit; (h) focus; (i) blur; 0) move; (k) key press; (1) touch; (m) change; (n) refresh; (o) open; (p) close; (q) redirect; (r) enter; (s) exit; (t) end of program; (u) beginning of program; (v) end of session; (w) change of service; (x) time; (y) sound; and (z) a combination of at least two of said trigger events of (a)-(y).

8. The method as claimed in claim 1, wherein step of providing services further comprising steps of:
(a) determining said service to request;
(b) requesting said determined service from one or more service sources;
(c) retrieving said requested service data from said service sources;
(d) displaying one or more service interfaces according to said retrieved service data to said users in one or more service displays;
(e) collecting data input from said users via said service interfaces;
(f) and, processing said collected data.

9. The method as claimed in claim 8, wherein said service sources are selected from a group comprising of: (a) an advertiser server; (b) an advertisement network server; (c) a publisher server; (d) a local processing system; (e) a third party service server; and (f) a combination of at least two of said service sources of (a)-(e).

10. The method as claimed in claim 8, wherein said advertisement display, trigger display, and service display are selected from a group comprising of: (a) a Web site; (b) a Web page; (c) interactive media; (d) video broadcast content; and (e) audio broadcast content.

11. The method as claimed in claim 8, wherein said advertisement display is said trigger display.

12. The method as claimed in claim 8, wherein said advertisement display is said service display.

13. The method as claimed in claim 8, wherein said step of processing said collected data includes steps selecting from a group comprising of: (a) assembling said collected data into a formatted file and sending said file to a destination using a suitable function according to said formatted file; (b) writing said collected data to a storage means for future use; (c) generating a decision according to said collected data, outputting said decision to said user, and writing said decision to a storage means for future use; (d) updating said collected data to a database; (e) opening a connection to a server using said collected data; and (f) a combination of at least two of said steps of processing said collected data of (a)-(e).

14. The method as claimed in claim 1, wherein said service is selected from a group comprising of:
(a) a contact service enabling said user to contact said whereby said user can request customer services and provide feedback;
(b) a transfer service enabling said user to send said advertisement related information to different entities via different communication media whereby said user can tell other entities about the said advertisement via different media;
(c) a survey service enabling said advertiser to conduct surveys, polls, and questionnaires whereby said advertiser can take advantage of the advertisement penetration ability to conduct surveys;
(d) a coupon service enabling said advertiser to distribute coupons and rebates to said user whereby said advertiser can distribute said coupons efficiently and do company branding at the same time;
(e) a demonstration service enabling said advertiser to display one or more content, said one or more content including advertiser related software functions, electronic image, text, video, and audio whereby advertisers can show a summary of their business via said advertisement delivery terminals;
(f) a chat service enabling user to log on to a chat;
(g) and, a combination of at least two of said services of (a)-(f).

15. The method as claimed in claim 14, wherein said survey service comprises of: (a) one or more questions; and (b) plurality of potential answers according to said questions for said user to choose from.

16. The method as claimed in claim 14, wherein said coupon service comprises of: (a) said coupons related data including a coupon identifier, a coupon image, and a coupon source; (b) an option to redeem said coupons directly via said advertisement delivery terminals; (c) an option to write to a storage means for saving said coupons; and (d) an option to transfer said coupons to another entities via a communication media.

17. A method enabling a user to post data to an advertiser via an advertisement delivery terminal, said method comprising steps of:
(a) displaying one or more content in said advertisement delivery terminal, said contents are selected from a group comprising of: a contact form whereby said user can enter contact information, a transfer form whereby said user can enter electronic contact information of other entities, a survey form containing one or more survey questions and choices according to said survey questions, a coupon redemption form, a demonstration content whereby said advertisers can shows additional information according to businesses of said advertisers, and a combination of at least two of said contents;
(b) accepting data from said user using said content;
(c) collecting said accepted data in response to a submit event;
(d) and, processing said collected data.

18. The method as claimed in claim 17, wherein said advertisement delivery terminal is selected from a group comprising of: (a) an web page related advertisement space; (b) an mobile wireless application protocol page related advertisement space; (c) an audio broadcast advertisement channel; (d) a interactive television advertisement slot; (e) an electronic advertisement billboard; and (f) an offline advertisement electronic display device slot.

19. The method as claimed in claim 18, wherein said step of processing said collected data includes steps selecting from a group comprising of: (a) assembling said collected data into a formatted file and sending said file to a destination using a suitable function according to said formatted file; (b) writing said collected data to a storage means for future use; (c) generating a decision according to said collected data, outputting said decision to said user, and writing said decision to a storage means for future use; (d) updating said collected data to a database; (e) opening a connection to a server using said collected data; and (f) a combination of at least two of said steps of processing said collected data of (a)-(e).

20. The method as claimed in claim 18, wherein said submit event is selected from a group comprising of: (a) select; (b) moveover; (c) load; (d) unload; (e) click; (f) resize; (g) submit; (h) focus; (i) blur; (j) move; (k) key press; (l) touch; (m) change; (n) refresh; (o) open; (p) close; (q) redirect; (r) enter; (s) exit; (t) end of program; (u) beginning of program; (v) end of session; (w) change of service; (x) time; (y) sound; and (z) a combination of at least two of said trigger events of (a)-(y).
